(19) United States
(12) Patent Application Publication
(10) Pub. No.: US 2026/0002385 A1
(43) Pub. Date: Jan. 1, 2026

(54) ELONGATE FLEXIBLE SECURITY APPARATUS AND METHOD OF USING THE SAME

(71) Applicant: SE-KURE CONTROLS, INC., Franklin Park, IL (US)

(72) Inventors: Patrick C. Panico, Berwyn, IL (US); Jordan Drumgoole, Des Plaines, IL (US)

(21) Appl. No.: 18/760,987

(22) Filed: Jul. 1, 2024

(51) Int. Cl. E05B 73/00

(52) U.S. Cl. CPC E05B 73/0005

(57) ABSTRACT

An elongate flexible security apparatus has connecting parts each defined by pieces which, when connected in an operative relationship, cooperatively produce spaced surrounded openings at which a pivot connection can be established with adjacent connecting parts of similar, or the same, configuration. The invention is also directed to a method of securing a portable article using the elongate flexible security apparatus.

### BACKGROUND OF THE INVENTION

### Field of the Invention

This invention relates to security apparatus and, more particularly, to an elongate flexible apparatus usable commonly to control access to, and/or unauthorized repositioning of, movable articles.

### Background Art

Elongate flexible apparatus take many different forms and are used in a wide range of security applications, ranging generally from limiting access to confining movement of articles away from a particular site.

As one example, elongate flexible apparatus are often used to prevent opening of doors and gates. In another application, elongate flexible apparatus are used to confine movement of articles away from a particular location. For example, elongate flexible apparatus are commonly used to “lock” bikes at an anchoring location, control the movement of portable electronic articles away from a kiosk, or the like, at which they are displayed, etc.

The elongate flexible apparatus may be connected in different manners to articles or parts thereof, as by using connectors, using locks, creating lasso configurations, etc.

The nature of the elongate flexible apparatus varies considerably, depending upon the level of security required, budget constraints, etc.

As just examples, the elongate flexible apparatus may be in the form of a wire, a hardened or unhardened metal cable, a chain, etc.

While the applications for these elongate flexible apparatus are unlimited, for purposes of simplicity, the invention herein will be focused on one particular application; that being to confine movement of portable articles, such as portable electronic articles, as at displays in retail establishments. This application is but exemplary and should not be viewed as limiting the potential uses for the invention herein.

Given the expense of modern electronic articles, it is common to mechanically confine movement of the articles away from a location at which they are displayed. These displays are commonly set up so that a potential purchaser can handle and operate the articles, thereby to promote sales. Commonly, elongate flexible apparatus are connected between an anchoring location and the portable article to allow the portable article to be maneuvered within a range, dictated by the length of the elongate flexible apparatus, and potentially other components it is used in association with.

Commonly, in displaying small electronics, an electrically conductive cable/wire is utilized that performs the dual purposes of providing some mechanical restraint while at the same time allowing incorporation of different electronic features related to the operation of the apparatus and/or securing and/or monitoring thereof. However, this type of cable relies principally on electronic security features since it can be readily cut by someone attempting an unauthorized removal.

To provide an additional security level, heavier gauge metal cables are commonly utilized. When metal cables are utilized, there are a number of competing objectives that designers contend with. First of all, it is desirable that the cables are flexible enough that they are not difficult to reconfigure during setup and do not significantly interfere with maneuvering of an article to which they are connected.

Increasing gauge adds a level of security but increases rigidity and expense. Hardening also increases the level of security but as well adds to the cost of the apparatus.

It is also known to use elongate apparatus in the form of metal chains with a conventional link construction. While these chains may have a substantial tensile strength that resists rupture in response to a large applied tensile force, these chains are typically vulnerable to being cut.

With relatively small links, the flexibility of the chain, which is desirable, also allows a person to reconfigure a part of the chain to expose a link length that can be readily cut with a conventional tool. Providing hardened chain material adds considerably to the cost. Enlarging the chain links, either in loop size or gauge to increase strength, adds considerably to the effective diameter of the chain links, which makes it impractical in certain applications, particularly when secured portable articles are relatively small.

Thus, while chains are in many respects most desirable, particularly because of their flexibility, regardless of size, they remain vulnerable to being cut. That is, a relatively large link can be grasped, with the adjoining links strategically spaced so as to expose a substantial region that can be conveniently accessed and cut. Metal hardening addresses this issue but adds to expense.

Designers of flexible security apparatus in many different areas are challenged with the task of developing designs that are reliably secure, while at the same time being convenient to use and practical to purchase, as gauged by the anticipated loss from theft of unsecured products. These characteristics are particularly desirable when the security apparatus are required to be used in large numbers, as to secure individual articles, which may number in the dozens at retail establishments at which portable electronic articles are displayed to facilitate consumer handling and inspection.

### SUMMARY OF THE INVENTION

In one form, the invention is directed to an elongate flexible security apparatus having a plurality of relatively movable connecting parts that are joined to produce a combined length for the elongate flexible security apparatus. A first of the plurality of connecting parts includes: a) a first piece having a body with first and second receptacles, respectively with first and second entryways; and b) a second piece having a second body with third and fourth receptacles, respectively with third and fourth entryways. The first piece and second piece are configured to be moved between: a) a starting relationship wherein paths exist from locations spaced from the first body: i) through the first entryway into the first receptacle and through the second entryway into the second receptacle; and from locations spaced from the second body ii) through the third entryway into the third receptacle and through the fourth entryway into the fourth receptacle and; b) an operative relationship wherein the first and second pieces cooperate to: A) block each of the paths through the first, second, third, and fourth entryways successively into the first, second, third, and fourth receptacles; B) define spaced first and second substantially fully surrounded openings respectively defined by: a) at least part of the first and fourth receptacles; and b) at least part of the second and third receptacles. A second of the plurality of connecting parts has a portion extendable through one of the first and second substantially fully surrounded openings and configured to define a pivoting connection between the first of the plurality of connecting parts and the second of the plurality of connecting parts.

In one form, the second of the plurality of connecting parts has a same configuration as the first of the plurality of connecting parts.

In one form, a third of the plurality of connecting parts has a substantially same configuration as the first of the plurality of connecting parts. A portion of the third of the plurality of connecting parts is extendable through the other of the first and second substantially fully surrounded openings and is configured to define a pivoting connection between the first of the plurality of connecting parts and the third of the plurality of connecting parts.

In one form, the first piece and the second piece have the same configuration with the first receptacle corresponding to the third receptacle and the second receptacle corresponding to the fourth receptacle.

In one form, the first body on the first piece has an elongate shape with a middle location midway between lengthwise spaced ends. The first receptacle is closer to one of the lengthwise spaced ends than to the middle location. The second receptacle is closer to the other of the lengthwise spaced ends than to the middle location.

In one form, the body on the first piece is in a form of a flat sheet.

In one form, the first and second pieces in the operative relationship are fixed together.

In one form, the first and second pieces in the operative relationship are welded together.

In one form, the first and second pieces are made from a metal material.

In one form, each of the first and second pieces has a substantially flat shape parallel to a reference plane and a substantially oval shape as viewed from a perspective orthogonally to the reference plane.

In one form, the elongate flexible security apparatus further includes a confining connector unit having a portion extendable through the other of the substantially fully surrounded openings. The confining connector unit is configured to define a pivoting connector between the confining connector unit and the first of the plurality of connecting parts. The elongate flexible security apparatus is provided in combination with an anchoring base. The elongate flexible security apparatus is connected to the anchoring base through the confining connector unit.

In one form, the connector unit is configured to be releasably connected to the anchoring base.

In one form, the elongate flexible security apparatus further includes an article connecting unit with a portion extendable through the other of the substantially fully surrounded openings. The article connecting unit is configured to define a pivoting connection between the article connector unit and the first of the plurality of connecting parts.

In one form, the elongate flexible security apparatus is provided in combination with a portable article operably engaged with the article connecting unit.

In one form, the elongate flexible security apparatus further includes a confining connector unit that has a portion extendable through the other of the substantially fully surrounded openings. The confining connector unit is configured to define a pivoting connector between the confining connector unit and the first of the plurality of connecting parts. The elongate flexible security apparatus is provided in combination with an anchoring base. The elongate flexible security apparatus is connected to the anchoring base through the confining connector unit.

In one form, the elongate flexible security apparatus is provided in combination with a portable article operatively engaged with the article connecting unit. The portable article is confined in movement relative to the anchoring base within a range dictated by a length of the elongate flexible security apparatus.

In one form, the elongate flexible security apparatus is provided in combination with a portable article. A portion of the elongate flexible security apparatus is directed through a part of the portable article to operatively engage the portable article.

In one form, the invention is directed to a method of securing a portable article. The method includes the steps of: obtaining the elongate flexible security apparatus described above; connecting the elongate flexible security apparatus to an anchoring base; and operatively engaging the portable article with the elongate flexible security apparatus. The portable article is confined in movement relative to the anchoring base within a range dictated by a length of the elongate flexible security apparatus.

In one form, the step of operatively engaging the portable article with the elongate flexible security apparatus involves directing a portion of the elongate flexible security apparatus through a part of the portable article.

In one form, the portable article is a portable electronic device.

### BRIEF DESCRIPTION OF THE DRAWINGS

FIG. 1 is a schematic representation of an elongate flexible security apparatus, according to the present invention, including two operatively engaged connecting parts, each in turn made up of joined first and second pieces;

FIG. 2 is a schematic representation of the connecting parts in FIG. 1 and showing further details of structure cooperating therebetween;

FIG. 3 is a schematic representation of the elongate flexible security apparatus in FIGS. 1 and 2 connecting between an anchoring base and a portable article;

FIG. 4 is a schematic representation of a connecting part, as shown schematically in FIG. 1, joined to an anchoring base through a confining connector unit;

FIG. 5 is a schematic representation of a connecting part, shown schematically in FIG. 1, and with an article connector unit joining the connecting part to a portable article to be secured;

FIG. 6 is an elevation view of one exemplary form of the first piece, as shown schematically in FIG. 1, and in relationship to a schematically depicted second piece;

FIG. 7 is an end elevation view of the first piece in FIG. 6;

FIG. 8 is a perspective view of the first piece, in FIGS. 6 and 7, in a starting relationship to a specific form of second piece, as shown schematically in FIG. 6;

FIG. 9 is a view as in FIG. 8 wherein the first and second pieces have been connected in an operative relationship;

FIG. 10 is an elevation view of the components in the FIG. 9 state;

FIG. 11 is an enlarged, fragmentary, elevation view showing two representative first pieces, on separate connecting parts, joined preparatory to adding a second piece to each of the first pieces to define pivotably connected connecting parts;

FIG. 12 is a plan view of one form of elongate flexible security apparatus, using the components in FIGS. 6-11, and including specific forms of the confining connector unit, as shown schematically in FIG. 4, and connected to an anchoring base in the form of a housing, through an article connecting unit, as shown schematically in FIG. 5;

FIG. 13 is a perspective view of the components in the FIG. 12 state;

FIG. 14 is a side elevation view of the components as in FIG. 13, with the elongate flexible security apparatus turned through 90° relative to the housing;

FIG. 15 is a cross-sectional view of the components taken along line 15-15 of FIG. 14 and with the elongate flexible security apparatus, in the orientation of FIGS. 12 and 13 relative to the housing;

FIG. 16 is an enlarged, exploded, perspective view of the housing in FIGS. 12-15 and the confining connector unit, as shown in those same Figures, and with a cover on the housing in an open position;

FIG. 17 is a view of the components from the FIG. 15 perspective with a modified form of the confining connector unit and with a sleeve surrounding the connecting parts and portions of the confining connector unit and the article connector unit on the elongate flexible security apparatus;

FIG. 18 is a fragmentary, cross-sectional view of the components taken along line 18-18 of FIG. 17;

FIG. 19 is a reduced, perspective view of the components as in FIGS. 17 and 18;

FIG. 20 is an elevation view of the elongate flexible security apparatus with the confining connector unit in FIGS. 17-19 operatively connected with a modified form of housing and with the elongate flexible security apparatus turned 90°, from the orientation in FIGS. 17-19, relative to the housing;

FIG. 21 is an elevation view of the components in FIG. 20 from a different perspective;

FIG. 22 is a cross-sectional view of the components taken along line 22-22 of FIG. 21 and with a cover on the housing in an open position;

FIG. 23 is a reduced, perspective view of the components in the state of FIGS. 21 and 22;

FIG. 24 is a partial cross-sectional view as in FIG. 22 wherein the confining connector unit, as in FIGS. 17-23, is used on the elongate flexible security apparatus;

FIG. 25 is a view as in FIG. 6 and showing a modified form for the first piece;

FIG. 26 is a perspective view of the first piece in FIG. 25;

FIG. 27 is a flow diagram representation of a method of securing a portable article using the inventive elongate flexible security apparatus;

FIG. 28 is a schematic representation showing connection between the inventive elongate flexible security apparatus and a portable article; and

FIG. 28 is a schematic depiction of a modified form of the inventive elongate flexible security apparatus formed into a lasso.

### DETAILED DESCRIPTION OF THE PREFERRED EMBODIMENT

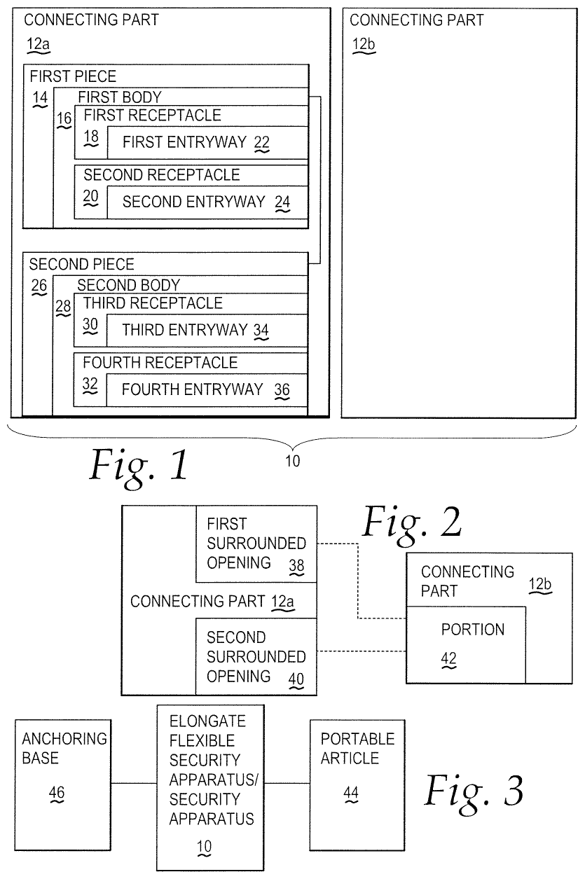

An elongate flexible security apparatus, according to the present invention, is shown schematically at 10 in FIG. 1. The security apparatus 10 consists of a plurality of relatively movable connecting parts 12. In FIG. 1, two connecting parts 12a, 12b are shown. The actual number of connecting parts 12 is not limited and is generally dictated by the desired overall length of the security apparatus 10. Details of the connecting part 12a will be described, with it being understood that the details of the connecting part 12b would be the same or similar, as would the details of any additional connecting parts 12 utilized in making up the security apparatus 10.

The connecting part 12a has a first piece 14 having a first body 16 with a first receptacle 18 and a second receptacle 20. The first receptacle 18 has an associated first entryway 22, with the second receptacle 20 having an associated second entryway 24.

The connecting part 12a has a second piece 26 with a second body 28 having a third receptacle 30 and a fourth receptacle 32. The third receptacle 30 has an associated third entryway 34, with the fourth receptacle 32 having an associated fourth entryway 36.

The first piece 14 and second piece 26 are configured to be moved between: a) a starting relationship wherein paths exist from a location spaced from the first body 16: i) through the first entryway 22 into the first receptacle 18 and through the second entryway 24 into the second receptacle 20; and from a location spaced from the second body 28: ii) through the third entryway 34 into the third receptacle 30 and through the fourth entryway 36 into the fourth receptacle; and: b) an operative relationship wherein the first and second pieces 14, 26 cooperate to: A) block each of the paths through the first, second, third, and fourth entryways 22, 24, 34, 36 successively into the first, second, third, and fourth receptacles 18, 20, 30, 32; and B) define spaced first and second substantially fully surrounded openings 38, 40, as shown in FIG. 2 and defined by: a) at least part of the first and fourth receptacles 18, 32; and b) at least part of the second and third receptacles 20, 30.

The connecting part 12b has a portion 42 extendable through one of the first and second surrounded openings 38, 40 and is configured to define a pivoting connection between the connecting part 12a and the connecting part 12b.

The schematic depiction of components in FIGS. 1 and 2 is intended to encompass virtually an unlimited number of variations of these components and their interactions. As just one example, the shapes of the bodies 16, 28, the receptacles 18, 20, 30, 32 and entryways 22, 24, 34, 36 is not limited so long as they function in the manner described. The specific forms of the invention described hereinbelow are exemplary in nature only and should not be viewed as limiting.

Further, the security apparatus 10 can be used in virtually any manner that other elongate flexible security apparatus, such as ropes, cables, chains, etc., are used. As shown schematically in FIG. 3, one exemplary use involves connecting the security apparatus 10 between a portable article 44 and an anchoring base 46.

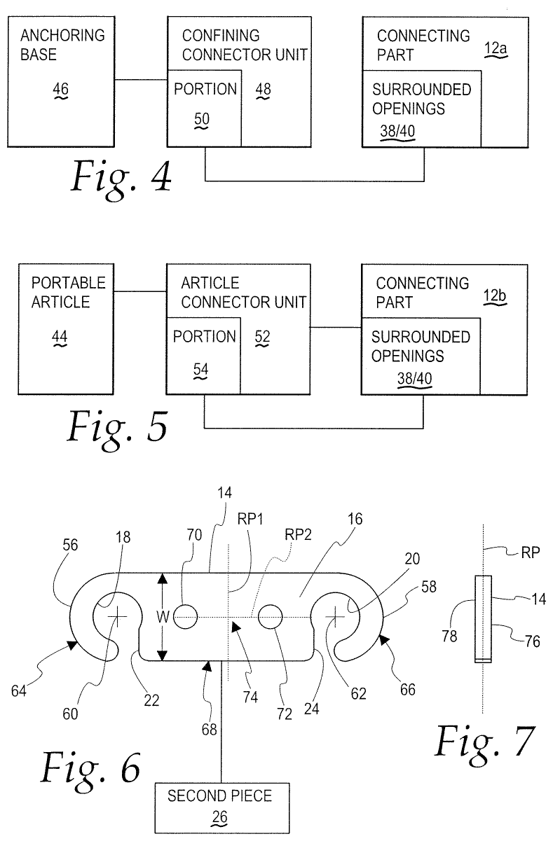

In one form, as shown schematically in FIG. 4, a confining connector unit 48 is provided and has a portion 50 extendable through one of the surrounded openings 38, 40 on the connecting part 12a to make a pivoting connection between the confining connector unit 48 and the connecting part 12a. The confining connector unit 48 is fixedly or releasably connectable to the anchoring base 46 through many potentially different structures, only certain of which will be described hereinbelow.

In another form, shown in FIG. 5, an article connector unit 52 is provided and has a portion 54 extendable through one of the surrounded openings 38, 40 on the connecting part 12a to define a pivoting connection therewith. The article connector unit 52 has an appropriate structure to connect to the portable article 44 being secured.

The confining connector unit 48 and article connector unit 52, as described and claimed herein, may be considered to be either part of the elongate flexible security apparatus 10, or separately attached components.

Referring now to FIGS. 6-24 and 28, exemplary forms of the elongate flexible security apparatus 10 will now be described.

In FIG. 6, one exemplary form of the first piece 14 is shown in detail, with the cooperating second piece 26 shown schematically therein. The first body 16 has an elongate shape between lengthwise spaced ends 56, 58. The first receptacle 18 is closer to the end 56, with the second receptacle 20 closer to the end 58.

The first body 16 is formed from a flat piece of material, preferably metal, that can be considered to reside within a reference plane RP, as seen in FIG. 7. In the form depicted, the first body 16 is symmetrical about reference planes RP1, RP2, each orthogonal to the reference plane RP, with the reference plane RP1 residing at a middle location midway between the ends 56, 58 of the first body 16 and the reference plane RP2 bisecting a width W of the first body 16.

In the depicted form, the first body 16 has an oval shape as viewed from a perspective orthogonally to the reference plane RP.

As depicted, the first and second receptacles 18, 20 respectively have central axes 60, 62 and are bounded by curved edges traced by arcs centered on the axes 60, 62. An outer edge portion 64 of the first body 16 at the end 56 is curved and traced by an arc centered on the axis 60. A corresponding outer edge portion 66 is defined at the body end 58.

The first entryway 22 and second entryway 24 are formed through a lengthwise edge 68 of the first body 16 to be in communication with the first receptacles 18, 20, respectively. Accordingly, separate paths are defined from spaced locations externally of the first body 16: a) through the first entryway 22 into the first receptacle 18; and b) from the second entryway 24 into the second receptacle 20.

Locating openings 70, 72 are defined respectively between a middle location 74, equidistantly spaced from the ends 56, 68 of the first body 16, and the first and second receptacles 18, 20, respectively.

While the second piece 26 can have a different configuration than the first piece 14, in one preferred form, the second piece 26 has the same configuration as the first piece 14. The description will be focused on this construction, noting that this single shape design has advantages in terms of being a manufacturing expedient, but is not a requirement.

The first piece 14, as seen in FIG. 7, has oppositely facing flat surfaces 76, 78 that are substantially parallel to each other.

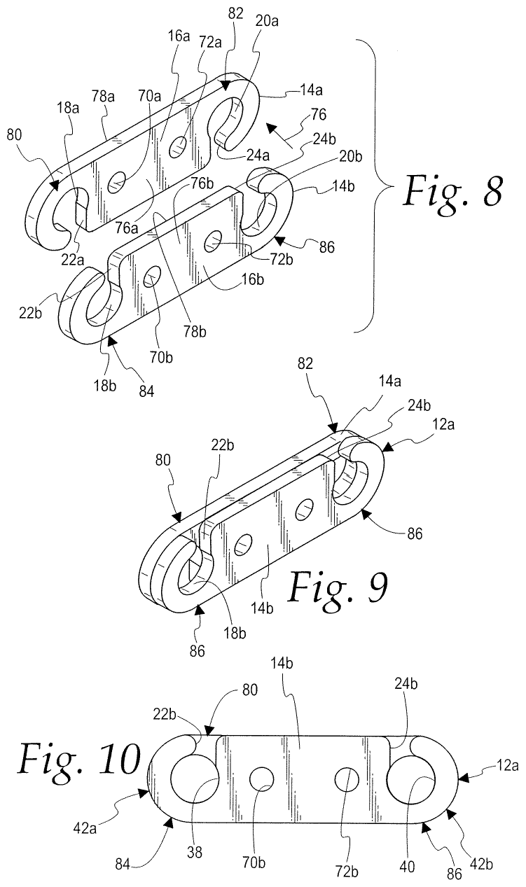

The description hereinbelow, starting with FIG. 8, will relate to connecting parts 12 wherein the first piece 14 will be identified as 14a and the second piece 26 will be identified as 14b, which has an identical construction as the first piece 14a.

As shown in FIG. 8, one of the pieces 14a, 14b is inverted from the other after which the surface 78b is placed against the surface 76a with the peripheral edge shapes of the pieces 14a, 14b matched, as shown in FIGS. 9 and 10, wherein the pieces 14a, 14b are in the aforementioned operative relationship. It should be noted that the symmetrical configuration allows the surface 78b to be alternatively placed facially against the surface 78a to achieve the same function and configuration.

As seen in FIGS. 8-10: a) the region at 80 on the piece 14a above the receptacle 18a blocks the entryway 22b on the piece 14b; b) the region at 82 on the piece 14a above the receptacle 20a blocks the entryway 24b on the piece 14b; c) the region at 84 on the piece 14b below the receptacle 18b blocks the entryway 22a on the piece 14a; and d) the region at 86 on the piece 14b below the receptacle 20b blocks the entryway 24a on the piece 14a. The “blocking” of the entryways 22a, 24a, 22b, 24b means paths are blocked: a) into and through the entryway 22a into the receptacle 18a; b) into and through the entryway 24a into the receptacle 20a; c) into and through the entryway 22b into the receptacle 18b; and d) into and through the entryway 24b into the receptacle 20b.

With the pieces 14a, 14b in the operative relationship of FIGS. 9 and 10, the cooperating bodies 16a on the piece 14a and 16b on the piece 14b cooperatively define the fully surrounded openings 38, 40, identified schematically in FIG. 2. In this operative relationship, the locating openings 70a, 70b register, as do the openings 72a, 72b. The locating openings 70, 72 may be used to facilitate consistent placement of the pieces 14a, 14b in their operative relationship of FIGS. 9 and 10 and may also be used to facilitate fixing of the pieces 14a, 14b together.

The pieces 14a, 1b may be fixed together in their operative relationship through welding. The pieces 14a, 14b may be fixed together in other manners known to those skilled in the art including, without limitation, as by using an adhesive, mechanical interlocking pieces, mechanical fasteners, etc.

The pieces 14a, 14b in the operative relationship also define portions 42a, 42b on the connecting part 12a that correspond to the portion 42 on the connecting part 12b, as shown schematically in FIG. 2.

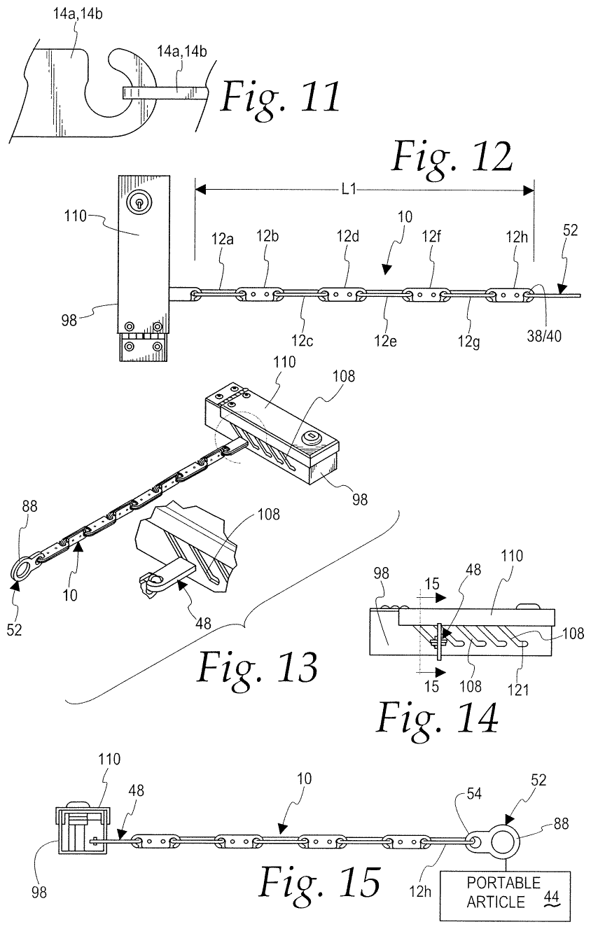

The connecting parts 12 are connected to each other by directing the portions 42a, 42b through the surrounded opening 38, 40 on adjacent connecting parts 12 to establish a pivoting connection thereat. This relationship is established by initially placing one of the first and second pieces 14a, 14b in orthogonal relationship with another of the first and second pieces 14a, 14b, as shown in FIG. 11, and hooking the ends, as shown. Thereafter, complementary pieces 14a, 14b are joined to the pieces 14a, 14b to produce the connecting part configurations, as shown in FIGS. 9 and 10, that are pivotably connected as shown in FIG. 12.

FIG. 6 shows one form of the first piece 14 to scale, which allows the described connection of pieces 14, 26, and pivotable connection of the parts 12, to produce the desired overall length of the securing apparatus 10.

In FIGS. 12-16, one exemplary form of the securing apparatus 10 is depicted, with eight operatively joined connecting parts 12a, 12b, 12c, 12d, 12e, 12f, 12g, 12h defining an overall length L1, with each of the connecting parts 12 being pivotably connected to an adjacent connecting part 12.

The end connecting part 12h is pivotably connected to one exemplary form of the article connector unit 52 defining an anchoring ring 88. The anchoring ring 88 may be extended through an opening in the portable article 44, may be fixed thereto, or otherwise connected thereto.

The article connector unit 52 has the aforementioned portion 54, as depicted schematically in FIG. 5, which extends through one of the surrounded openings 38, 40 on the connecting part 12h to define a pivoting connection therewith.

The connecting part 12a at the opposite end has the confining connector unit 48, shown schematically in FIG. 4, with the portion 50 extendable through one of the surrounded openings 38, 40 on the connecting part 12a to establish a pivoting connection therewith. In this form, the confining connector unit 48 has a body 90 with a fully surrounded opening 92 around which the portion 50 is defined.

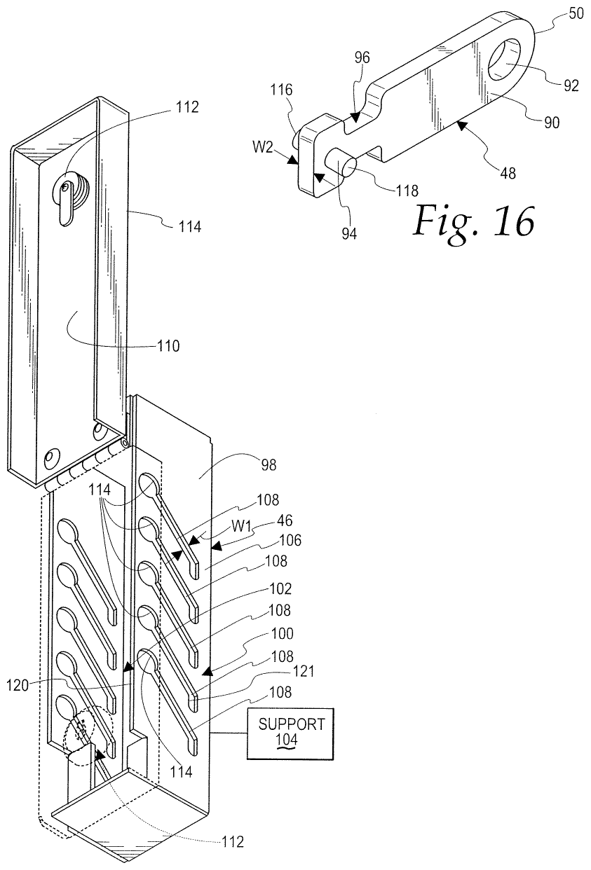

As seen most clearly in FIG. 16, the body 90 depicted has an elongate, flat shape with the portion 50 at one lengthwise end and a locking pin 94 adjacent, or closer, to the opposite end. The body 90 has a necked region 96 adjacent to where the pin 94 is located. The pin 94 may be pressed in place in an opening through the body 90 so that parts thereof project in opposite directions away from the body 90.

The confining connector unit 48 is designed to cooperate with the anchoring base 46, which in the exemplary depicted form is a lockbox with a housing 98 having a squared configuration with a peripheral wall at 100 extending around a space 102. The housing 98 is suitably anchored to a support 104, shown schematically in FIG. 16.

The peripheral wall 100 has a wall portion 106 with spaced, generally L-shaped closed slots 108 extending fully therethrough.

The slots 108 each has a width W1 that is slightly greater than the width/thickness W2 of the body 90 on the confining connector unit 48.

A hinged cover 110 is provided on the housing 98 and is pivotably movable between an open position, as shown in solid lines in FIG. 16, and a closed position, as shown in dotted lines also in FIG. 16. Through a key-operated lock assembly at 112, the cover 110 can be fixedly maintained in the closed position.

In the open position, the end of the confining connector unit 48 at which the pin 94 is located can be directed through a selected, circular opening/entryway 114 at the top of the “L” shape and of a diameter adequate to allow the pin 94 to pass therethrough. With the pin 94 residing within the space 102, the body 90 can be turned to align the width W2 of the body 90 with the width W1 of the selected slot 108, whereupon the body 90 can be guided along the slot 108 away from the entryway 114. Oppositely projecting parts 116, 118 of the pin abut to an inside surface 120 on the wall portion 106 to prevent the confining connector unit 48 from being drawn outwardly from the space 102 away from the housing 98. With the cover 110 thereafter moved to the closed position, the door 110 overlies and partially or fully blocks the entryways 114, thereby preventing separation of the confining connector unit 48 on the security apparatus 10 from the housing 98.

The necked portion 96 of the confining connector unit 48 has an effective diameter that allows it to be turned within each slot 108. This allows the elongate flexible security apparatus 10 to be turned through 360° about its length relative to the wall portion 106.

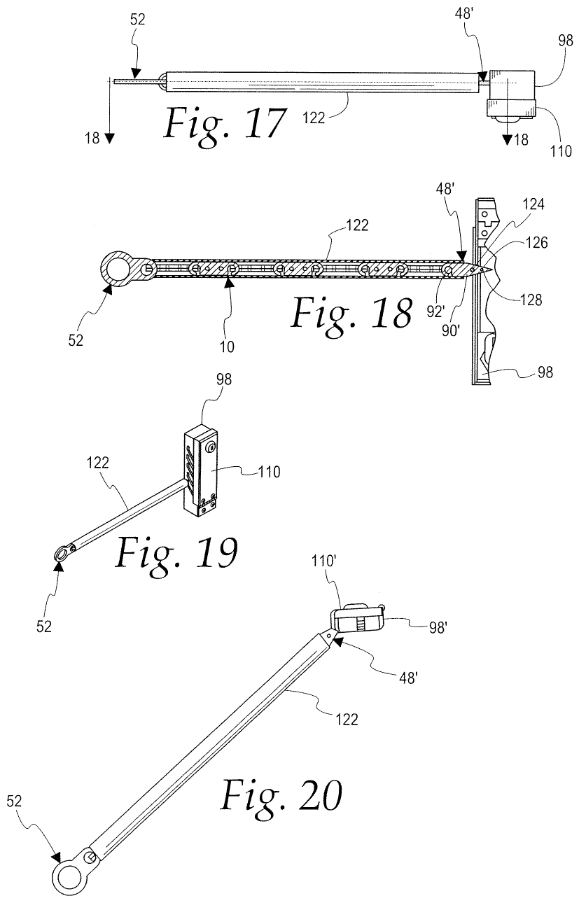

In FIGS. 17-23, an optional sleeve 122 is shown surrounding the apparatus 10 over at least a portion of a length thereof. As depicted, the sleeve 122 extends around a part of the article connector unit 52 and a part of a modified form of confining connector unit 48′. The sleeve 122 can be made from a flexible material, such as rubber, to maintain the flexibility of the security apparatus while providing a smoother overall outer surface while at the same time inhibiting direct access to the individual connecting parts 12.

The modified form of confining connector 48′ has a tapered body 90′ with two alternative pin locations 124, 126. The pin location 124 has a bore with a larger diameter bore than a bore at the pin location 126, whereby different pin sizes can be directed therethrough and used to match a selected configuration for the housing 98 and provide the desired strength of holding.

In FIGS. 17-19 a pin 128 is used at the pin location 126 to prevent separation of the confining connector unit 48′ from the housing 98.

The tapered configuration allows the aforementioned turning of the security apparatus 10 about its length relative to the housing 98, when used therewith as shown in FIGS. 17-19, by situating a reduced width within the enlarged regions of the slots 108, to perform similarly to the aforementioned necked region 96 on the body 90.

FIGS. 20-24 show an alternative form of the housing at 98′ that has a shallower construction, as to accommodate a single confining connector unit 48, 48′ in each slot, whereas the housing 98 might accommodate multiple of the confining connector units 48.

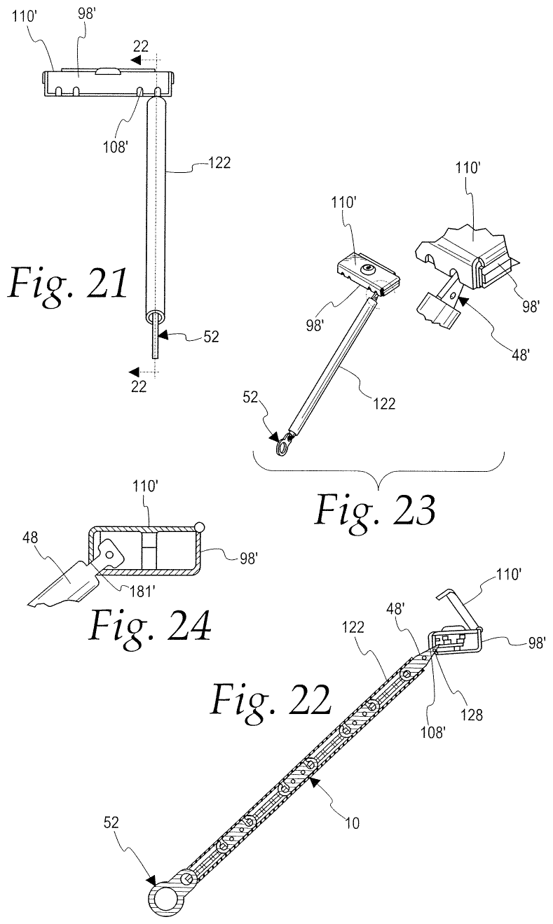

A corresponding cover 110′ is pivotable between an open position, as shown in FIG. 22, and a closed position, as shown in each of FIGS. 21, 23, and 24.

With the cover 110′ open, the pin 128 on the confining connector unit 48′ is placed in a slot 108′ in the housing 98′ and blocked at the base thereof by the cover 110′ in the closed position.

The construction of the housing 98′ and connector unit 48′ may be such that the security apparatus 10 may be turned around its length, as shown in FIG. 23, relative to the housing 98′.

In FIG. 24, the confining connector unit 48 is used in place of the confining connector unit 48′ and is blocked in place within a slot 181′ on the housing 98′ with the cover 110′ closed.

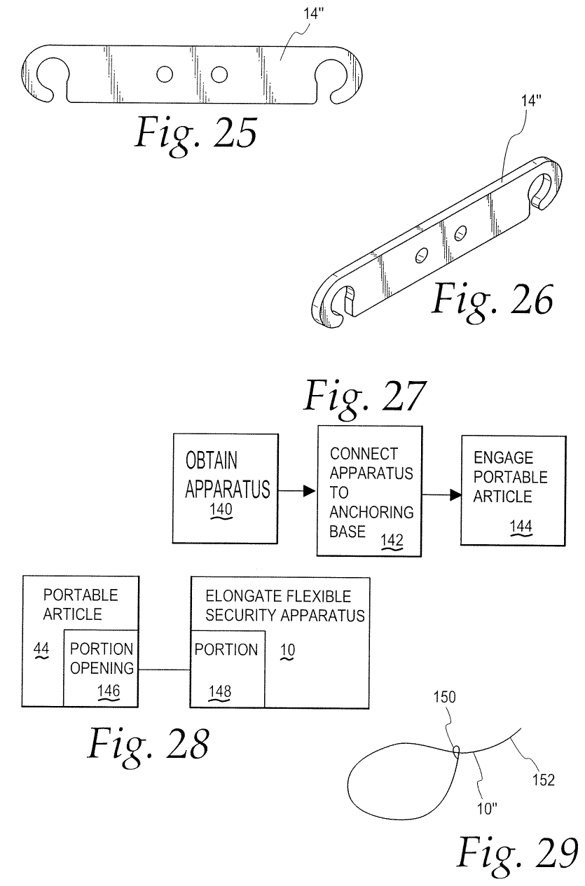

As shown in FIGS. 25 and 26, the first body 16 may be lengthened from the FIG. 7 configuration whereby fewer connecting parts 12 may be required to produce the same desired length for the security apparatus 10. The first piece 14″, as shown in FIGS. 19 and 20, is usable in substantially the same manner as the aforementioned first piece 14.

The operatively positioned pieces 14, 26 in each connecting part 12 are preferably made of metal. The thicknesses of the pieces 14, 26 are shown to be equal; however, this is not required. In one exemplary form, the pieces 14, 26 are made from thirteen gauge metal material, with the pieces 14, 26 welded together.

Materials other than metal might be used, with benefit resulting from the efficient and cost-reasonable process of forming the security apparatus 10 using the joined pieces 14, 26.

The inventive design has desirable durability by reason of the double thickness of the pieces 14, 26. Further, the portions of the connecting parts 12 that interact to produce a pivot connection may be made so that the interengaged portions are not readily accessible to be cut, compared to conventional open-link chain designs.

In one form, the operatively connected pieces 14, 26 are shown to be identical. The same advantages can be realized by having the pieces 14, 26 substantially the same in that they cooperate with each other, and function in substantially the same manner, as described above.

The openings 38, 40 are characterized as substantially fully surrounded since certain interruptions of the edges surrounding the openings 38, 40 may exist without significantly altering the integrity of the connecting part 12.

The invention is also directed to a method of securing a portable article, as shown in flow diagram form in FIG. 27.

As shown at block 140, an elongate flexible security apparatus, as described above, is obtained.

As shown at block 142, the elongate flexible security apparatus is connected to an anchoring base.

As shown at block 144, the portable article is operatively engaged with the flexible security apparatus whereby the portable article is confined in movement relative to the anchoring base within a range dictated by the length of the elongate flexible anchoring apparatus.

As shown in FIG. 28, the portable article 44 may have a portion/opening 146 through which a portion 148 of the elongate flexible security apparatus 10 is directed in connecting the elongate flexible security apparatus 10 to the portable article 44.

As shown schematically in FIG. 29, another form of the elongate flexible security apparatus 10″ may be formed with a loop 150 through which a length 152 can be directed to form a lasso-type connection.

The foregoing disclosure of specific embodiments is intended to be illustrative of the broad concepts comprehended by the invention.

1. An elongate flexible security apparatus comprising:
a plurality of relatively movable connecting parts that are joined to produce a combined length for the elongate flexible security apparatus,
a first of the plurality of connecting parts comprising: a) a first piece having a body with first and second receptacles respectively with first and second entryways; and b) a second piece having a second body with third and fourth receptacles respectively with third and fourth entryways,
the first piece and second piece configured to be moved between: a) a starting relationship wherein paths exist from locations spaced from the first body: i) through the first entryway into the first receptacle and through the second entryway into the second receptacle; and from locations spaced from the second body ii) through the third entryway into the third receptacle and through the fourth entryway into the fourth receptacle and; b) an operative relationship wherein the first and second pieces cooperate to: A) block each of the paths through the first, second, third, and fourth entryways successively into the first, second, third, and fourth receptacles; B) define spaced first and second substantially fully surrounded openings respectively defined by: a) at least part of the first and fourth receptacles; and b) at least part of the second and third receptacles,
a second of the plurality of connecting parts having a portion extendable through one of the first and second substantially fully surrounded openings and configured to define a pivoting connection between the first of the plurality of connecting parts and the second of the plurality of connecting parts.

2. The elongate flexible security apparatus according to claim 1 wherein the second of the plurality of connecting parts has a same configuration as the first of the plurality of connecting parts.

3. The elongate flexible security apparatus according to claim 2 wherein a third of the plurality of connecting parts has a substantially same configuration as the first of the plurality of connecting parts and a portion of the third of the plurality of connecting parts is extendable through the other of the first and second substantially fully surrounded openings and is configured to define a pivoting connection between the first of the plurality of connecting parts and the third of the plurality of connecting parts.

4. The elongate flexible security apparatus according to claim 1 wherein the first piece and the second piece have a same configuration with the first receptacle corresponding to the third receptacle and the second receptacle corresponding to the fourth receptacle.

5. The elongate flexible security apparatus according to claim 1 wherein the first body on the first piece has an elongate shape with a middle location midway between lengthwise spaced ends, and the first receptacle is closer to one of the lengthwise spaced ends than to the middle location and the second receptacle is closer to the other of the lengthwise spaced ends than to the middle location.

6. The elongate flexible security apparatus according to claim 1 wherein the body on the first piece is in a form of a flat sheet.

7. The elongate flexible security apparatus according to claim 3 wherein the first and second pieces in the operative relationship are fixed together.

8. The elongate flexible security apparatus according to 7 wherein the first and second pieces in the operative relationship are welded together.

9. The elongate flexible security apparatus according to claim 1 wherein the first and second pieces are made from a metal material.

10. The elongate flexible security apparatus according to claim 1 wherein each of the first and second pieces has a substantially flat shape parallel to a reference plane and a substantially oval shape as viewed from a perspective orthogonally to the reference plane.

11. The elongate flexible security apparatus according to claim 1 further comprising: a confining connector unit having a portion extendable through the other of the substantially fully surrounded openings and configured to define a pivoting connector between the confining connector unit and the first of the plurality of connecting parts, wherein the flexible security apparatus is provided in combination with an anchoring base and the flexible security apparatus is connected to the anchoring base through the confining connector unit.

12. The elongate flexible security apparatus according to claim 11 wherein the connector unit is configured to be releasably connected to the anchoring base.

13. The elongate flexible security apparatus according to claim 1 further comprising an article connecting unit with a portion extendable through the other of the substantially fully surrounded openings and configured to define a pivoting connection between the article connector unit and the first of the plurality of connecting parts.

14. The elongate flexible security apparatus according to claim 13 in combination with a portable article operably engaged with the article connecting unit.

15. The elongate flexible security apparatus according to claim 13 further comprising a confining connector unit having a portion extendable through the other of the substantially fully surrounded openings and configured to define a pivoting connector between the confining connector unit and the first of the plurality of connecting parts, wherein the flexible security apparatus is provided in combination with an anchoring base and the flexible security apparatus is connected to the anchoring base through the confining connector unit.

16. The elongate flexible security apparatus according to claim 15 in combination with a portable article operatively engaged with the article connecting unit whereby the portable article is confined in movement relative to the anchoring base within a range dictated by a length of the elongate flexible security apparatus.

17. The elongate flexible security apparatus according to claim 1 in combination with a portable article and a portion of the elongate flexible security apparatus is directed through a part of the portable article to operatively engage the portable article.

18. A method of securing a portable article, the method comprising the steps of:
obtaining the elongate flexible security apparatus of claim 1;
connecting the elongate flexible security apparatus to an anchoring base; and
operatively engaging the portable article with the elongate flexible security apparatus,
whereby the portable article is confined in movement relative to the anchoring base within a range dictated by a length of the elongate flexible security apparatus.

19. The method of securing a portable article according to claim 18 wherein the step of operatively engaging the portable article with the elongate flexible security apparatus comprises directing a portion of the elongate flexible security apparatus through a part of the portable article.

20. The method of securing a portable article according to claim 19 wherein the portable article is a portable electronic device.
